(19) United States
(12) Patent Application Publication
(10) Pub. No.: US 2026/0147791 A1
(43) Pub. Date: May 28, 2026

(54) QUERY PROCESSING APPARATUS AND METHOD BASED ON DISTRIBUTED SMALL LARGE LANGUAGE MODEL

(71) Applicant: Electronics and Telecommunications Research Institute, Daejeon (KR)

(72) Inventors: Hyun-Hwa Choi, Daejeon (KR); Dae-Won Kim, Daejeon (KR); Jae-Geun Cha, Daejeon (KR); Sun-Wook Kim, Hwaseong-si (KR)

(73) Assignee: Electronics and Telecommunications Research Institute, Daejeon (KR)

(21) Appl. No.: 19/400,583

(22) Filed: Nov. 25, 2025

(30) Foreign Application Priority Data
Nov. 28, 2024 (KR) 10-2024-0173536
Oct. 17, 2025 (KR) 10-2025-0150208

(51) Int. Cl. G06F 16/332; G06F 16/334

(52) U.S. Cl. CPC G06F 16/332; G06F 16/3347

(57) ABSTRACT

Disclosed herein are a query processing apparatus and method based on a distributed small Large Language Model (sLLM). The query processing apparatus based on a distributed sLLM may be configured to receive a query from a user, complement a prompt corresponding to the query based on a result of similarity search of searching a preset local vector database for local data similar to the query, select a remote sLLM suitable for the query based on a result of similarity search of searching a preset global vector database for an embedding vector similar to the query, and integrate a response of the local sLLM to the complemented prompt and a response of the remote sLLM, and output an integrated result.

### CROSS REFERENCE TO RELATED APPLICATIONS

This application claims the benefit of Korean Patent Application Nos. 10-2024-0173536, filed November 28, 2024 and 10-2025-0150208, filed October 17, 2025, which are hereby incorporated by reference in their entireties into this application.

### BACKGROUND OF THE INVENTION

### 1. Technical Field

The present disclosure relates generally to a large language model-based query processing technology, and more particularly to a query processing technology based on a distributed small Large Language Model (sLLM).

### 2. Description of the Related Art

With the recent development of artificial intelligence technology, a Large Language Model (LLM) has attracted attention in various natural language processing fields. Unlike conventional search-based systems or rule-based Chatbots, an LLM is capable of performing advanced functions such as generating natural sentences, responding to complex queries, and understanding contextual situations by learning large-scale datasets. However, because such an LLM includes billions or more parameters, enormous computational resources and memory are required, and thus there is a limitation that the LLM is mainly operated on high-performance Graphics Processing Unit (GPU) servers or cloud infrastructures.

For example, Chatbot services that support question-answering based on large language models such as ChatGPT have the advantage of being able to make queries across various domains. However, the Chatbot services require massive computing resources, power, and manpower, thus making it difficult to operate such services unless they are provided by large vendors (companies). Further, for queries targeting specific domains such as medical care, education, and law, the lack of specialization results in a failure to satisfy user expectations.

Meanwhile, a problem arises in that enterprises and individual users tend to hesitate to use the Chatbot services due to the security risk that private data can be leaked. In addition, as the demand for a personalized service increases, the number of requests to provide personalized responses in consideration of users’ personal data or specific domain knowledge is increasing. For example, in specialized domains such as medical care, law, education, and internal enterprise document search, general responses provided by general-purpose LLMs are not sufficient, and the need for specialized models associated with user data has been emphasized. For this, there has been made an attempt to fine-tune and utilize a small Large Language Model (sLLM) at the level of a personal terminal.

However, because an edge device such as a personal terminal is limited in computational resources and storage space, there are fundamental constraints in large-scale data processing and model execution. Further, a problem arises in that it is difficult to secure sufficient training or question-answering quality using only data owned by each individual user. Furthermore, when synchronization between personal data and external data is not performed, recency and accuracy may be deteriorated, thus becoming a factor that lowers user reliability.

Therefore, there is required a technology that is capable of processing personalized queries by utilizing data shared by a remote server or an external group together with personal data while efficiently utilizing limited resources even in an edge device environment.

This technology enables a lightweight AI model to be applied to personalized environments, and further allows collaborative utilization of pieces of data owned by multiple users, thus providing more reliable and adaptive question-answering results.

Meanwhile, U.S. Patent Application Publication No. US 2024-0311577 entitled “Personalized multi-response dialog generated using a large language model” discloses a method that receives natural language input from a client device, generates and scores multiple responses through an LLM, and then selects and renders a highest-scoring response subset.

### SUMMARY OF THE INVENTION

Accordingly, the present disclosure has been made keeping in mind the above problems occurring in the prior art, and an object of the present disclosure is to process user queries for a local sLLM fine-tuned with personal data and multiple remote sLLMs in order for an edge device having limited resources to support a large language model service personalized for individuals without the risk of information leakage to individuals or enterprises.

Another object of the present disclosure is to process queries for a sLLM fine-tuned with personal data and multiple sLLMs fine-tuned with pieces of data of other persons and to derive personalized query results, thus improving user satisfaction.

A further object of the present disclosure is to maintain recency by reflecting addition and modification of data when pieces of data of other persons, as well as personal data, are added and modified.

Yet another object of the present disclosure is to improve user satisfaction and prevent information exposure through public or commercial services without LLMs requiring large-scale resources even in specific application domains such as medical care, law, and administration.

In accordance with an aspect of the present disclosure to accomplish the above objects, there is provided a query processing apparatus based on a distributed small Large Language Model (sLLM), including one or more processors, and a memory configured to store at least one program that is executed by the one or more processors, wherein the at least one program is configured to receive a query from a user, complement a prompt corresponding to the query based on a result of similarity search of searching a preset local vector database for local data similar to the query, select a remote sLLM suitable for the query based on a result of similarity search of searching a preset global vector database for an embedding vector similar to the query, and integrate a response of the local sLLM to the complemented prompt and a response of the remote sLLM, and output an integrated result.

Here, the at least one program may be configured to determine preset application domains corresponding to keywords included in the query, and construct an embedding vector for searching the local vector database in accordance with the determined application domains.

Here, the at least one program may be configured to complement the query by adding meta-information including an access path to the local data to the query.

Here, the at least one program may be configured to determine preset application domains corresponding to keywords included in the query, and construct an embedding vector for searching the global vector database in accordance with the determined application domains.

Here, the result of similarity search on the global vector database may include summary information and access information for the remote sLLM.

Here, the at least one program may be configured to store the integrated output response in a query result cache, and provide a response stored in the query result cache with priority when an identical query is requested again.

In accordance with another aspect of the present disclosure to accomplish the above objects, there is provided a query processing method based on a distributed small Large Language Model (sLLM), performed by a query processing apparatus based on sLLM, the query processing method including receiving a query from a user, complementing a prompt corresponding to the query based on a result of similarity search of searching a preset local vector database for local data similar to the query; selecting a remote sLLM suitable for the query based on a result of similarity search of searching a preset global vector database for an embedding vector similar to the query; and integrating a response of the local sLLM to the complemented prompt and a response of the remote sLLM, and outputting an integrated result.

Here, complementing the prompt may include determining preset application domains corresponding to keywords included in the query, and constructing an embedding vector for searching the local vector database in accordance with the determined application domains.

Here, complementing the prompt may further include complementing the query by adding meta-information including an access path to the local data to the query.

Here, selecting the remote sLLM may include determining preset application domains corresponding to keywords included in the query, and constructing an embedding vector for searching the global vector database in accordance with the determined application domains.

Here, the result of similarity search on the global vector database may include summary information and access information for the remote sLLM.

Here, outputting the integrated result may include storing the integrated output response in a query result cache, and providing a response stored in the query result cache with priority when an identical query is requested again.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is a diagram illustrating the concept of edge computing according to an embodiment of the present disclosure;

FIG. 2 is a diagram illustrating an edge computing infrastructure according to an embodiment of the present disclosure;

FIG. 3 is a diagram illustrating the concept of an edge computing service according to an embodiment of the present disclosure;

FIG. 4 is a diagram illustrating a service use relationship between other technologies and an edge computing service according to an embodiment of the present disclosure;

FIG. 5 is a diagram illustrating a relationship for supporting edge computing capabilities provided by other technologies and edge computing according to an embodiment of the present disclosure;

FIG. 6 is a diagram illustrating the conceptual model of edge computing according to an embodiment of the present disclosure;

FIG. 7 is a block diagram illustrating a query processing apparatus based on a distributed sLLM according to an embodiment of the present disclosure;

FIG. 8 is a block diagram illustrating in detail an example of a local sLLM control module illustrated in FIG. 7;

FIG. 9 is a block diagram illustrating in detail an example of the remote sLLM query module illustrated in FIG. 7;

FIG. 10 is an operation flowchart illustrating a query processing method based on a distributed sLLM according to an embodiment of the present disclosure;

FIG. 11 is a diagram illustrating a query processing procedure based on a distributed sLLM according to an embodiment of the present disclosure; and

FIG. 12 is a diagram illustrating a computer system according to an embodiment of the present disclosure.

### DESCRIPTION OF THE PREFERRED EMBODIMENTS

The present disclosure will be described in detail with reference to the attached drawings. Repeated descriptions and descriptions of known functions and configurations which have been deemed to make the gist of the present disclosure unnecessarily obscure will be omitted below. The embodiments of the present disclosure are provided to more fully describe the present disclosure to those skilled in the art. Therefore, the shapes, sizes, etc. of elements in the drawings may be exaggerated for clear illustration.

In the entire specification, when a certain element is described as “comprising” or “including” a specific component, it means that, unless explicitly stated otherwise, the certain element may further include additional components without excluding the additional components.

The present disclosure may be variously modified and may have various embodiments, and the embodiments are intended to be illustrated and described in detail in the accompanying drawings.

However, this is not intended to limit the present disclosure to particular embodiments, and it should be appreciated that all changes, equivalents, and substitutes that do not depart from the spirit and technical scope of the present disclosure are encompassed in the present disclosure.

In description of components of the embodiment of the present disclosure, terms such as first, second, A, B, (a), and (b) may be used. These terms are used merely to distinguish one component from other components, and the essentials, order, or sequence of the components are not limited by the terms.

Unless otherwise defined, all terms including technical and scientific terms used herein have the same meaning as commonly understood by one of ordinary skill in the art to which the present disclosure belongs. Terms that are generally defined in commonly used dictionaries should be construed as having meanings consistent with their contextual usage in the relevant technical field, and, unless explicitly defined in this application, and should not be construed in an idealized or unduly formal sense.

It will be understood that when a component is referred to as being “associated” with another component, it can be directly associated with or connected to the other component, but other intervening components may be present therebetween.

The terms used in the present disclosure are used only to describe a specific embodiment, and are not intended to limit the present disclosure. A singular expression includes a plural expression unless a description to the contrary is specifically pointed out in context. It will be further understood that the terms “comprise”, “include”, “have”, etc. when used in this specification, specify the presence of stated features, numbers, steps, operations, elements, or combinations thereof but do not preclude the possibility of the presence or addition of one or more other features, numbers, steps, operations, elements, or combinations thereof.

Hereinafter, embodiments of the present disclosure will be described in detail with reference to the attached drawings. In the description of the present disclosure, independent reference numerals are used to designate the same components in the drawings to facilitate overall understanding.

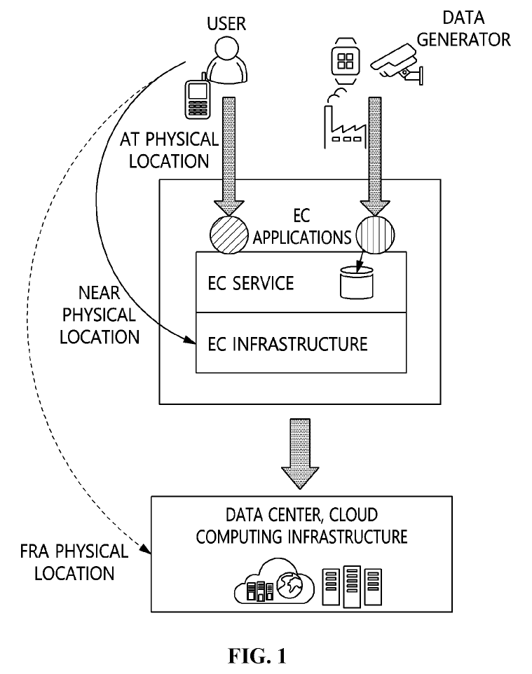

FIG. 1 is a diagram illustrating the concept of edge computing according to an embodiment of the present disclosure.

Referring to FIG. 1, edge computing included in a distributed cloud system according to an embodiment of the present disclosure is defined as a computing technology that enables data processing at or near a physical location where data is generated and consumed. In this definition, the edge refers to the physical location where data is generated or consumed.

An edge computing application is an end-to-end business logic provided to a user. The edge computing application may be implemented using an edge computing service, and may be executed on an edge computing infrastructure.

The edge computing service is a service having one or more edge computing capabilities that provide the edge computing application using the edge computing infrastructure. The edge computing service may be provided in various forms.

The edge computing infrastructure may be an infrastructure at the physical location where the edge computing application is executed and data is stored, or near the physical location. The edge computing infrastructure may have various types depending on the resources and resource configurations.

The resource types of the edge computing infrastructure may include physical or software resources which support computing, storage, networks, and the like.

The physical resources may include a server, a personal computer, an embedded system device, a mobile device, a physical data center, and the like.

The software resources may include software programs, operating systems, virtual resources such as containers, virtual machines, or virtual resources provided by a Cloud Service Provider (CSP).

The edge computing infrastructure may include a set of physical and software resources provided by the corresponding service, interconnected resources, and other technical infrastructures (e.g., cloud computing, IoT, big data, and the like).

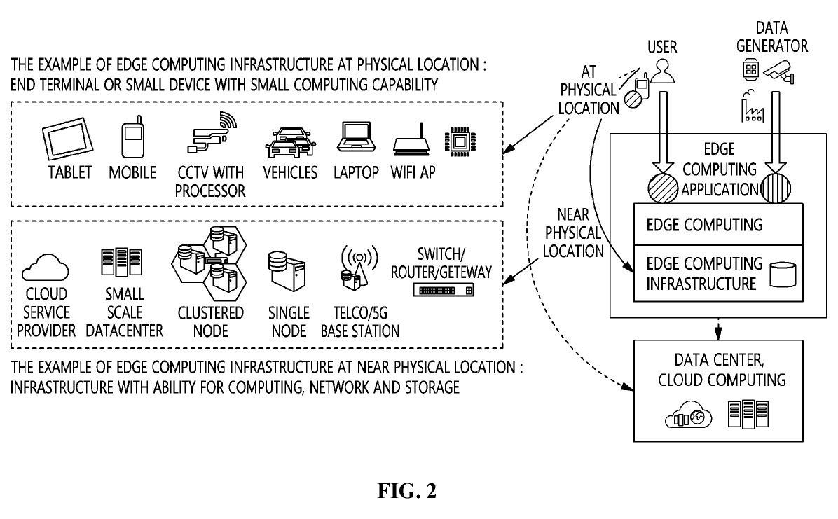

FIG. 2 is a diagram illustrating an edge computing infrastructure according to an embodiment of the present disclosure.

Referring to FIG. 2, the edge computing infrastructure may include various types, and may include software resources and physical resources. Also, the edge computing infrastructure may include one or more interconnected edge computing infrastructures.

As various applications emerge with the development of IT technologies, applications have produced new system requirements, and edge computing for better service quality and performance has many advantages in satisfying the requirements of various applications.

Various applications that use edge computing may include smart factories, gaming, autonomous vehicles, transportation, smart cities, smart retail, smart robots, smart homes, healthcare, smart agriculture, smart grids, smart buildings, etc.

Edge computing may minimize network latency attributable to remote access and large-capacity data transmission in a centralized processing environment.

Edge computing may perform high-speed transmission and storage of large-capacity data attributable to an increase in the number of devices in the Internet-of-Things (IoT).

Edge computing may perform real-time access and processing on pieces of data having heterogeneous characteristics and located at different geographical locations.

Edge computing may provide an effective service suitable for an ultra-high speed mobile communication technology such as 5G.

The concept of edge computing may be divided into a user perspective and a technical perspective.

In the user perspective of edge computing, edge computing users may be divided into all users, applications or systems that use an edge computing service and generate or consume data using an edge computing application. Each edge computing user may utilize a high-speed network to access the edge computing application with a minimum network distance.

The network distance refers to the shortest path between two points connected through the corresponding network. In addition, edge computing may measure the shortest path even within a single edge computing infrastructure. The edge computing infrastructure may include interconnected resources.

The user perspective of edge computing may include the use of an application located closest to the user in order to minimize service latency.

The user perspective of edge computing may include the use of an application located closest to the user in order for a data generator to store data.

The user perspective of edge computing may include the use of an application located closest to data so as to prevent data movement caused by data processing and minimize transmission frequency.

The edge computing application from the technical perspective of edge computing may be executed on an edge computing infrastructure having a minimum network distance between the user and the edge computing infrastructure. Edge computing may provide network connectivity to other Information and Communication Technology (ICT) infrastructures, such as cloud computing and data centers, in order to deploy the edge computing application closer to the user.

The edge computing application may include single software, or a software set.

Edge computing may support the edge computing application at physically remote locations by utilizing connectivity between other ICT infrastructures and the edge computing infrastructure. Also, the edge computing infrastructure may resolve resource constraints and distribute excessive workloads through collaboration among the connected infrastructures. Edge computing may minimize data movement by deploying edge computing applications that use proximate data for collaboration.

Examples of excessive workloads may include machine learning education, real-time image processing for Virtual Reality (VR) and Augmented Reality (AR), and real-time storage and analysis of big data.

Collaboration for edge computing refers to operating multiple Edge Computing (EC) infrastructures together with other ICT infrastructures so as to provide an edge computing application that satisfies system requirements.

Collaboration for edge computing may offload the edge computing application on a larger scale and migrate the edge computing application for user proximity between EC infrastructures and other ICT infrastructures.

Edge computing may provide orchestration for deployment, connectivity, coordination, and collaboration according to rules or policies optimized for various applications.

The orchestration for edge computing refers to a process that provides automated deployment, execution, control, and coordination of the edge computing application by using EC services according to optimization criteria.

From the technical perspective of edge computing, edge computing may provide orchestration for optimal utilization and availability based on connectivity with edge computing infrastructures, collaboration with cloud computing and large-scale data centers, and optimization rules or policies.

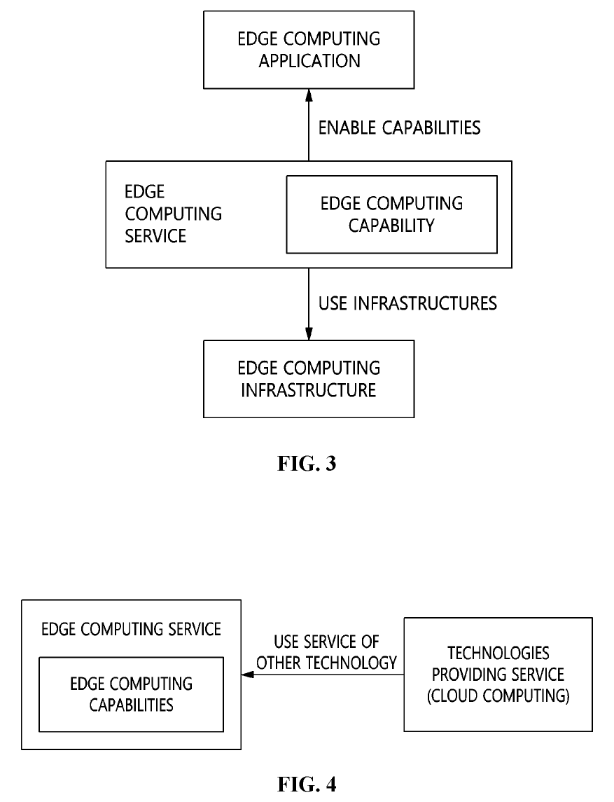

FIG. 3 is a diagram illustrating the concept of an edge computing service according to an embodiment of the present disclosure.

Referring to FIG. 3, edge computing has been developed along with various applications across industries. Also, from various applications across industries and the concept of edge computing, common characteristics may be derived.

The common characteristics of edge computing may include low latency, network connectivity, user proximity for data processing, data affinity, mobility support, infrastructure availability, infrastructure utilization, collaboration between infrastructures, and intelligence.

The low latency of edge computing is closely related to the response time experienced while the user is using the application. Low latency may occur due to network latency, processing delays, I/O bottlenecks, tail latency, and infrastructure failures.

The tail latency refers to a delay occurring at a specific location when edge computing applications are connected between different infrastructures and associated with each other.

In relation to network connectivity, the edge computing infrastructure may be connected to various infrastructures through edge computing services. An edge computing infrastructure that enables network connectivity may be utilized to deploy each edge computing application closer to the user to achieve low latency.

In addition, the edge computing infrastructure may be used for collaboration for edge computing applications.

Therefore, edge computing may provide a faster network and a shorter path to the edge computing applications.

Furthermore, edge computing may provide stable network connectivity between the user and each edge computing application by utilizing high availability.

Network connectivity may include a secure tunneling-based network using IPsec.

Also, network connectivity may include network proxy-based routing rules using the application layer of a Transmission Control Protocol (TCP).

The network proxy-based routing rules may correspond to basic routing for recognizing a gateway between network layers and the inside of the edge computing infrastructure.

The user proximity for data processing refers to data processing in which data is generated and consumed by defining edge computing. Edge computing may store data at a location closer to the user or process the data at minimum transmission for user proximity to perform data processing.

Data affinity refers to the degree to which data is approximate to the edge computing application. Edge computing may utilize an edge computing infrastructure in which data is present. Edge computing may share and synchronize data for data preference by utilizing interconnected infrastructures.

Mobility support may enable the provision of edge computing applications (e.g., autonomous drone, autonomous vehicle, etc.) equipped with mobility through various technologies such as by analyzing collected data and determining the behavior and role of vehicles. Edge computing may provide stable network connection and faster decision-making in the edge computing infrastructure.

Edge computing may provide the availability of the edge computing infrastructure that enables nearby infrastructures to be used so as to achieve user proximity for data processing. Therefore, edge computing may provide interfaces enabling access to the infrastructures depending on the types and configurations of resources.

Edge computing may consider resource constraints by utilizing the infrastructures when data is processed or service is provided. Therefore, edge computing may utilize a large-capacity data center or cloud computing infrastructure to achieve high performance, and may overcome resource constraints through resource extension and collaboration.

Edge computing may resolve resource constrains through collaboration among interconnected infrastructures, offload the edge computing applications to large-scale infrastructures, and redistribute workloads using migration for user proximity.

A migration process may include migration of edge computing applications and related data.

Application migration may include control processes such as checking the state of each edge computing application, identifying the target of each edge computing infrastructure, storing the current state of the edge computing application as a snapshot image, and restoring images.

Migration may store and restore snapshots showing the execution state of the corresponding edge computing application in real time by using shared or federated storage with a high-speed network (e.g., a kernel bypass network).

Offloading may include a function of transferring the role of resource-intensive computation processing to a data center equipped with hardware accelerators or larger-scale computing resources.

In relation to intelligence, with the recent advancement of artificial intelligence technologies, applications utilizing artificial intelligence have become key applications of edge computing. Edge computing may utilize artificial intelligence technologies for advanced functions of edge computing and provide edge computing applications by using various AI technologies together with edge computing capabilities.

In the concept of edge computing, the edge computing service may be defined as providing one or more functions through an edge computing infrastructure. Edge computing may provide edge computing capabilities that satisfy common characteristics so as to provide the edge computing service.

As illustrated in FIG. 3, the edge computing service may provide edge computing capabilities using the edge computing infrastructure.

Also, the edge computing service may provide an edge computing application that satisfies common characteristics to the user.

Furthermore, the edge computing service may provide various types of services through the edge computing infrastructures.

The edge computing service may provide not only a computing environment in which the edge computing application is executed, but also various interfaces for providing storage and network environments.

Various types of services provided by the edge computing infrastructures may include monolithic service forms, cloud services (e.g., PaaS), microservices including containers, event-based platform forms (e.g., serverless and FaaS), and the like.

The edge computing service may be provided as a single service, or may be combined with each service, thus providing edge computing capabilities to the user.

The edge computing capabilities are provided by the edge computing service to allocate common characteristics to the edge computing application. The edge computing capabilities may be provided in various manners depending on the characteristics requested by the edge computing application and the types of edge computing infrastructure.

The edge computing capabilities based on the common characteristics may include a low-latency function, a network connectivity function, a data preference function, a collaboration function, and an automated orchestration function.

The low-latency function may allocate low latency characteristics to the edge computing application.

The network connectivity function may connect the edge computing infrastructure to other infrastructures, may maintain stable connections between the edge computing infrastructure and other infrastructures, and may access the edge computing service and the edge computing application.

The data preference function may store and process data in the edge computing application or near the edge computing application.

The collaboration function may maximize the efficiency of interconnected infrastructures by offloading, migrating and replicating the edge computing application.

The automated orchestration function may provide automated deployment, execution, control, scheduling, and coordination of the edge computing application according to optimization criteria in order to achieve availability, interoperability, usability, and intelligence.

An edge computing ecosystem may include fundamental entities required to perform edge computing and the corresponding roles (tasks) of those entities, such as an edge computing customer (ECC), an edge computing partner (ECN), and an edge computing provider (ECP).

The edge computing customer (ECC) refers to a party corresponding to a natural person or a legal entity that acts on behalf of the relevant ECC in a business relationship for the purpose of using the edge computing application or edge computing service.

The primary activities of the ECC include, but are not limited to, the use of the edge computing application, performance of business management related to the edge computing service, and management of the edge computing application.

From the perspective of the edge computing customer, the ECC is a customer that uses the edge computing application through the edge computing service equipped with the edge computing capabilities. However, customers who use the EC service are merely developers who develop a new edge computing service and developers who develop an edge computing application through the edge computing service. In addition, EC service users who perform the same activities as the edge computing partner are not described in this recommendation.

The sub-roles and activities of the ECC are as follows.

An edge computing application user (ECC: AU) uses an edge computing application, which is the end-to-end business logic delivered to the user.

An edge computing service administrator (ECC: SA) may handle issues such as ensuring the normal operation of the edge computing services, monitoring edge computing services and edge computing infrastructures associated with them, and providing, upgrading, installing, and configuring interfaces for developers.

The edge computing application administrator (ECC:AM) may perform EC application management and business management.

The edge computing partner (ECN) is a party that supports or assists the activities of either or both of the edge computing provider and the edge computing customer. The activities of the ECN may vary depending on the partner type and the relationship between the edge computing provider and the edge computing services.

The sub-roles and activities of the ECN are as follows.

An edge computing service developer (ECN:SD) may activate the edge computing capabilities, and may develop a new edge computing service to be integrated with a current edge computing service.

An edge computing application developer (ECN:AD) may integrate and develop edge computing (EC) applications and data using the edge computing services.

The edge computing provider (ECP) is a party that provides the edge computing applications usable by ECC and the edge computing services usable by ECC and ECN. The activities of the ECP focus on providing, managing, and operating edge computing services and edge computing applications in order to provide the edge computing capabilities to the ECC.

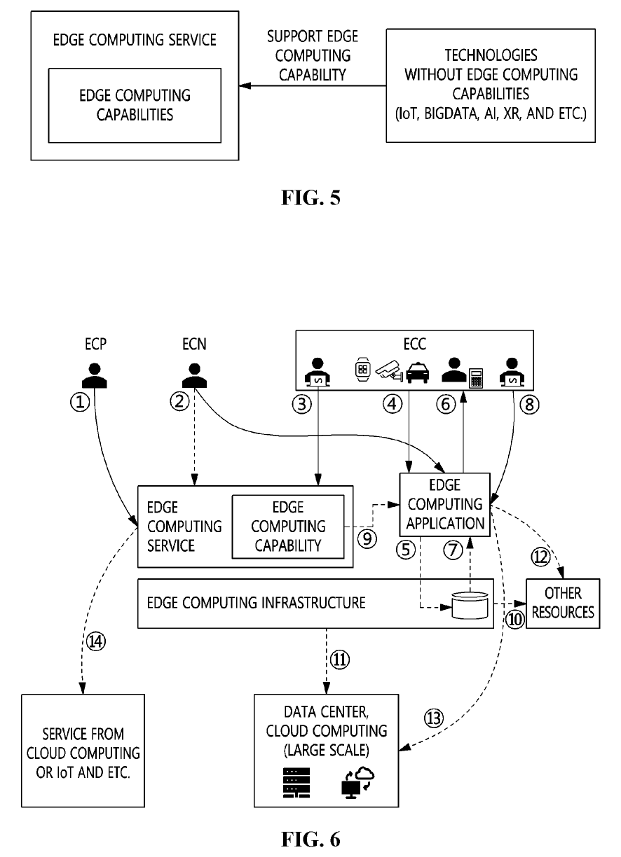

FIG. 4 is a diagram illustrating a service use relationship between other technologies and an edge computing service according to an embodiment of the present disclosure. FIG. 5 is a diagram illustrating a relationship for supporting edge computing capabilities provided by other technologies and edge computing according to an embodiment of the present disclosure.

Edge computing may provide an edge computing application through an edge computing service including edge computing capabilities. Although edge computing appears to be similar to technologies (e.g., IoT, Bigdata, machine learning, etc.) other than edge computing in that infrastructures provide various applications, there is the difference between edge computing and other technologies in the following aspects. The principal differences between the edge computing capabilities provided by the edge computing service may satisfy the common characteristics.

The relationship between other technologies and the edge computing may be divided into a service utilization relationship and a relationship supporting edge computing capabilities depending on whether edge computing competence is supported.

Referring to FIG. 4, it can be seen that the service utilization relationship between the other technologies, such as cloud computing, and the edge computing is illustrated.

Edge computing may provide edge computing capabilities, in the form of an edge computing service, using the service of other technologies, such as the cloud computing service. Also, the edge computing service may recreate a new edge computing service by utilizing the service of the other technologies. Therefore, the edge computing service may be created by maintaining a complementary relationship with a technology that provides a service such as cloud computing.

In the case of the cloud computing service (e.g., IaaS, PaaS, SaaS, etc.), edge computing may utilize the cloud computing service as an edge computing infrastructure.

For example, IoT services including low-latency, collaboration, and data affinity functions are provided through the EC service, and an IoT function for computing, storage, and analysis, defined in [ITU-T Y.2068], may be processed near IoT data sources. Therefore, IoT services such as an application service, a platform service, and a network service, defined in [ITU-T Y.2066], may be services utilized by the edge computing service to enable edge computing competence.

Big data, defined in [ITU-T Y.3600], may provide on-demand high-performance data processing, distributed storage, and various tools required to perform activities within a big data ecosystem. In the case of cloud computing-based big data, a big data service may be utilized as an edge computing service related to cloud services.

Referring to FIG. 5, it can be seen that, in order for edge computing to satisfy common characteristics required by various technologies, a relationship for supporting an edge computing service in other technologies lack of the edge computing capabilities is illustrated.

Edge computing may provide application of other technologies by introducing edge computing capabilities in other technologies.

An edge computing service for an IoT application that provides low-latency and data preference functions that are related to efficient data management of IoT may be supported.

In the case of big data, the provision of analysis services and infrastructure by big data service providers may utilize edge computing services to provide collaboration capabilities (e.g., preprocessing and temporary storage of data at the edge) and data affinity capabilities (e.g., data processing and analysis close to data for large-scale data processing).

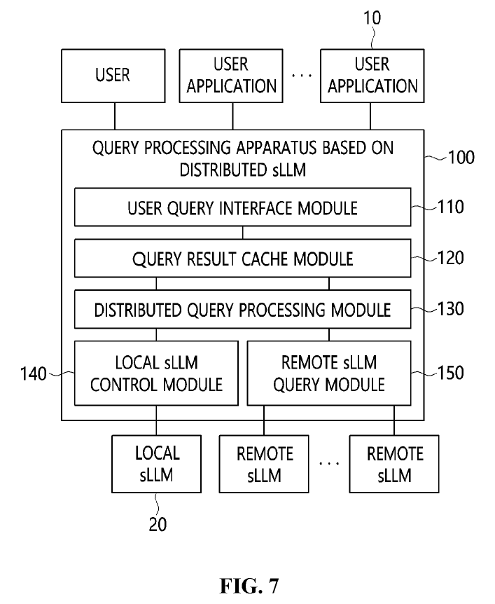

FIG. 6 is a diagram illustrating the conceptual model of edge computing according to an embodiment of the present disclosure.

Referring to FIG. 6, it can be seen that a conceptual model of edge computing for explaining the activities of edge computing is illustrated.

The conceptual model of edge computing may be derived from the concept and ecosystem of edge computing.

It can be seen that the conceptual model of edge computing indicates relationships between the components of the edge computing concept of FIG. 1 and the roles and activities of the edge computing ecosystem of FIG. 3. The relationships between the roles and components are indicated by arrows in FIG. 6, and the relationships between individual components may be described as follows.

An edge computing provider (ECP) may provide an edge computing service equipped with edge computing capabilities.

An edge computing developer (ECN) may develop an edge computing service and an edge computing application that support edge computing capabilities.

An edge computing service administrator of an edge computing customer (ECC:SA) may control and manage the edge computing service provided to the edge computing developer.

An edge computing customer (ECC) for a data generator may store data using the edge computing application, and may transmit the data for data affinity.

The edge computing application may store data in the storage of the edge computing infrastructure close to the physical location thereof.

The edge computing application user of the edge computing customer (ECC:AU) may use the edge computing application based on user proximity, and may consume data.

The edge computing application may process or transmit data in response to the request of the ECC:AU.

The edge computing application manager of the edge computing customer (ECC:AM) may control and manage the edge computing application to be provided to the ECC:AU.

The edge computing service may provide an edge computing capability to the edge computing application.

The edge computing infrastructure may extend a corresponding resource for a network connectivity function by connecting the corresponding resource to other resources.

The edge computing infrastructure may be connected to a data center or cloud computing so as to perform network connectivity function.

The edge computing application may be replicated or migrated to other resources for a collaboration function.

The edge computing application may offload the edge computing application to a large-scale data center for the collaboration function.

The edge computing service may create a new edge computing service or reuse the service in cloud computing, IoT or the like.

FIG. 7 is a block diagram illustrating a query processing apparatus based on a distributed sLLM according to an embodiment of the present disclosure.

Referring to FIG. 7, the query processing apparatus based on a distributed small Large Language Model (sLLM) (hereinafter also referred to as “distributed sLLM-based query processing apparatus”) according to an embodiment of the present disclosure may be operated on an edge device having limited resources, including a notebook, a Personal Computer (PC), or a mobile phone which directly interacts with the user. In particular, it is assumed that a local sLLM is fine-tuned using user data that utilizes the edge device.

The distributed sLLM-based query processing apparatus 100 may include a user query interface module 110, a query result cache module 120, a distributed query processing module 130, a local sLLM control module 140, and a remote sLLM query module 150.

A user and user applications 10 may deliver a user query to the distributed sLLM-based query processing apparatus 100 using a Graphical User Interface (GUI), an Application Programming Interface (API), a Command-Line Interface (CLI) utility, or the like provided by a user query interface.

The user query interface module 110 may receive the user query. The user query may contain information about a query target sLLM.

Upon receiving the user query, the user query interface module 110 may deliver the user query to the query result cache module 120 to determine whether the result of the query, stored in a cache, is present.

When there is the query result, the query result cache module 120 may return the query result to the user and the corresponding user application 10. Otherwise, the query result cache module 120 may return a result, obtained by delivering the user query to the distributed query processing module 130, to the user and the corresponding user application 10.

The query result cache module 120 may store and manage the latest or frequently occurring user queries and result data corresponding to the user queries in the cache.

The distributed query processing module 130 may integrate results obtained by delivering the user query to the local sLLM control module 140 and the remote sLLM query module 150 based on the user query.

The distributed query processing module 130 may return the integrated result to the user query interface module 110.

The local sLLM control module 140 may deliver a result, obtained by applying the received query to the local sLLM 20, to the distributed query processing module 130.

The remote sLLM query module 150 may deliver the received query to a server that supports remote sLLM services for the remote sLLMs 30, and may obtain the results of the query.

The remote sLLM query module 150 may return the results of processing the query to the distributed query processing module 130.

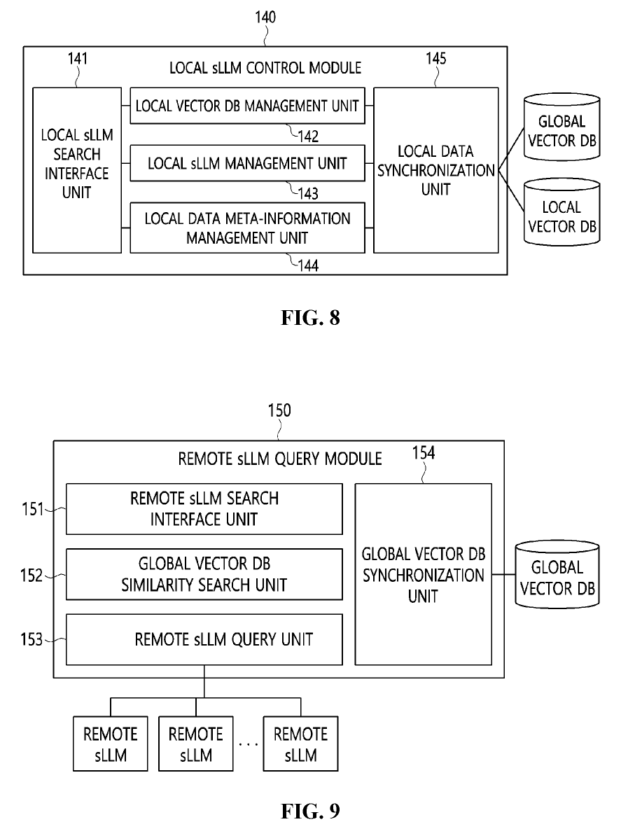

FIG. 8 is a block diagram illustrating in detail an example of a local sLLM control module illustrated in FIG. 7.

Referring to FIG. 8, the local sLLM control module 140 may include a local sLLM search interface unit 141, a local vector database (DB) management unit 142, a local sLLM management unit 143, a local data meta-information management unit 144, and a local data synchronization unit 145.

The local sLLM search interface unit 141 may receive a query from the distributed query processing module 130, may process the query based on the local vector DB management unit 142, the local sLLM management unit 143, the local data meta-information management unit 144, and may return the result of processing the query to the distributed query processing module 130.

First, the local sLLM search interface unit 141 may integrate the result obtained by delivering the query to the local vector DB management unit 142 with the received query, and then complementing the query to configure a new query.

Here, the query may be converted from a predefined form into a prompt format.

When the complemented query or prompt is delivered to the local sLLM management unit 143 and the result thereof is generated, the local sLLM search interface unit 141 may return the result to the distributed query processing module 130.

Additionally, after analyzing the query result returned from the local sLLM management unit 143, the local sLLM search interface unit 141 may add meta-information including an access path to the related local data to the query result through the local data meta-information management unit 144, and then return the added result to the distributed query processing module 130. In this case, when meta-information is not present, the query result may be refined and returned by removing the corresponding result from the search result of the sLLM.

The local vector DB management unit 142 may construct an embedding vector from a document, an image, text, or the like, which is local data, may store the embedding vector in the vector DB, may delete and modify the embedding vector, and may support similarity search.

Here, the local vector DB management unit 142 may utilize a technology such as word2vec, LSA, or GloVe, as a method for constructing the embedding vector corresponding to the query.

Here, the local vector DB management unit 142 may utilize and construct vector DBs ranging from an open source such as Faiss, Qdrant, Pineone, or Milvus to a commercial vector DB, as a vector DB, and may support a similarity search function.

The local sLLM management unit 143 may construct a sLLM fine-tuned with the local data, and may support a response (answer) to a natural language query.

The local data meta-information management unit 144 may manage meta-information such as an access path to local data, for example, documents, images, or video, and generation date and owners of the local data, through a Relational database (RDB).

The local data synchronization unit 145 may add newly generated user data or update modified data in the local vector DB that is composed of local data, in the local sLLM, or in the local data meta-information DB either on a specific cycle or in response to a user request.

Meanwhile, when a portion of the local data is deleted, the local data synchronization unit 145 may delete the corresponding data from a global vector DB and a local data DB.

The local data synchronization unit 145 may maintain the accuracy and recency of query results when a prompt for the sLLM is generated and the query results are refined.

The local data synchronization unit 145 may additionally extract summary information from the local vector DB and reflect the summary information in the global vector DB.

FIG. 9 is a block diagram illustrating in detail an example of the remote sLLM query module illustrated in FIG. 7.

Referring to FIG. 9, the remote sLLM query module 150 may include a remote sLLM search interface unit 151, a global vector DB similarity search unit 152, a remote sLLM query unit 153, and a global vector DB synchronization unit 154.

The remote sLLM search interface unit 151 may receive a query from the distributed query processing module 130.

Here, the remote sLLM search interface unit 151 may select a remote sLLM to which the query is to be input through the global vector DB similarity search unit, based on the received query.

Here, the number of selected remote sLLMs may be one or more.

Here, the remote sLLM search interface unit 151 may integrate query results returned by the selected remote sLLMs and return the integrated query result to the distributed query processing module 130.

Here, the remote sLLM search interface unit 151 may select the remote sLLMs based on the output data order or similarity score of the global vector DB.

The global vector DB similarity search unit 152 may perform similarity search on the global vector DB composed of summary information about pieces of data from persons belonging to a group or an enterprise that has agreed to share data in advance.

The global vector DB similarity search unit 152 may convert the query into an embedding vector, and thereafter select the top K results having the highest search scores from among similarity search results.

K may be a value equal to or greater than 1, and the selected results may include connection information, owner, position (job title), main keywords, and content for the remote sLLM. The global vector DB may be stored in the edge device, or may be connected to the global vector DB that is remotely located and may then be implemented in the form of a similarity search service.

The remote sLLM query unit 153 may receive a query and connection information from the remote sLLM search interface unit 151 to perform a query through the remote sLLM service.

The remote sLLM query unit 153 may return the result of performing the query to the remote sLLM search interface unit 151.

When the resources of the edge device are available, the global vector DB synchronization unit 154 may copy the global vector DB to a local area, and may support access so that the global vector DB similarity search unit 152 is capable of accessing the global vector DB.

Meanwhile, the global vector DB synchronization unit 154 may monitor whether the global vector DB has been modified, and may then perform update as needed.

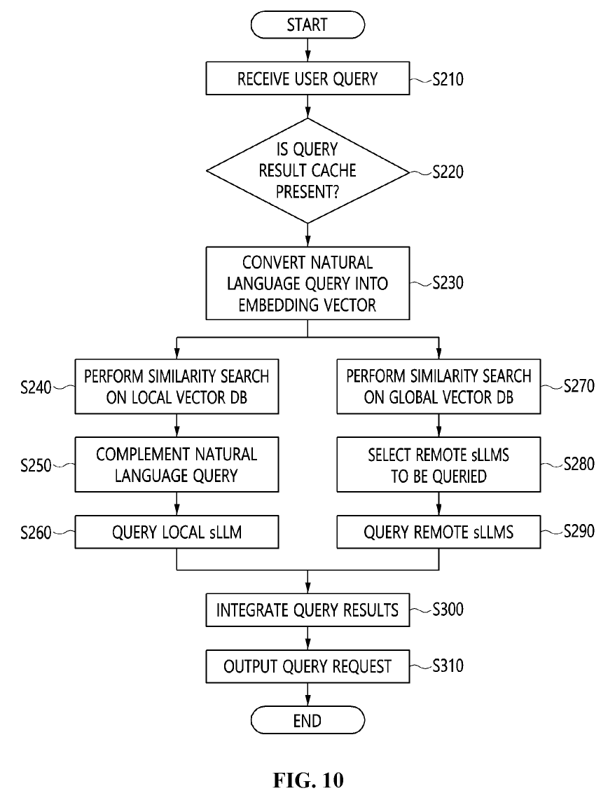

FIG. 10 is an operation flowchart illustrating a query processing method based on a distributed sLLM according to an embodiment of the present disclosure.

Referring to FIG. 10, the query processing method based on a distributed sLLM (hereinafter also referred to as “distributed sLLM-based query processing method”) according to the embodiment of the present disclosure may receive a user query at step S210.

That is, at step S210, a natural language-type query may be received from a user through an edge device.

Further, the distributed sLLM-based query processing method according to the embodiment of the present disclosure may determine whether a query result cache is present at step S220.

That is, at step S220, whether the corresponding query is stored in the cache may be determined. When it is determined that a query result cache corresponding to the query is not present, a natural language query may be converted into an embedding vector at step S230, whereas when the query result cache is present, the query result may be output at step S310.

Here, a model for generating the embedding vector may generate the same embedding vectors as a local vector DB and a global vector DB, respectively.

Here, at step S230, certain application domains for keywords included in the query may be determined, and embedding vectors for searching the local vector DB and the global vector DB, respectively, in accordance with the determined application domains may be constructed.

Furthermore, the distributed sLLM-based query processing method according to the embodiment of the present disclosure may perform similarity search on the local vector DB at step S240.

That is, at step S240, the user query may be converted into the embedding vector, and a result value may be obtained by performing similarity search on the local vector DB.

Here, at step S240, similarity search may be performed on the local vector DB using the generated embedding vector.

Furthermore, the distributed sLLM-based query processing method according to the embodiment of the present disclosure may complement the natural language query at step S250.

That is, at step S250, the user query may be complemented to include main keywords and a current state based on the search results, and thus a new query may be configured from the user query.

In this case, at step S250, meta-information including an access path to local data may be added to the query, and thus the user query may be complemented.

Here, at step S250, the new query may be configured depending on predefined rules.

Furthermore, the distributed sLLM-based query processing method according to the embodiment of the present disclosure may query the local sLLM at step S260.

That is, at step S260, the configured new query may be used as the input of the local sLLM, and then a first result may be obtained from the sLLM.

Furthermore, the distributed sLLM-based query processing method according to the embodiment of the present disclosure may perform similarity search on the global vector DB at step S270.

That is, at step S270, similarity search may be performed on the global vector DB using the embedding vector of the user query.

The results of similarity search may include key information (summary information) and access information (service-invocable information) for remote sLLMs.

In addition, the distributed sLLM-based query processing method according to the embodiment of the present disclosure may select remote sLLMs to be queried at step S280.

That is, at step S280, from the search results, remote sLLMs may be selected based on similarity criteria, or top one to three remote sLLMs may be selected.

Furthermore, the distributed sLLM-based query processing method according to the embodiment of the present disclosure may query the remote sLLMs at step S290.

That is, at step S290, the user query may be individually delivered to the selected remote sLLMs, and second results may be configured.

Furthermore, the distributed sLLM-based query processing method according to the embodiment of the present disclosure may integrate query results at step S300.

That is, at step S300, the query result may be generated by integrating the first result and the second results.

Here, at step S300, an integrated output response may be stored in the query result cache, so that, when the same query is requested again, the response stored in the query result cache may be provided with priority.

Furthermore, the distributed sLLM-based query processing method according to the embodiment of the present disclosure may output the query result at step S310.

That is, at step S310, the generated query result may be returned to the user.

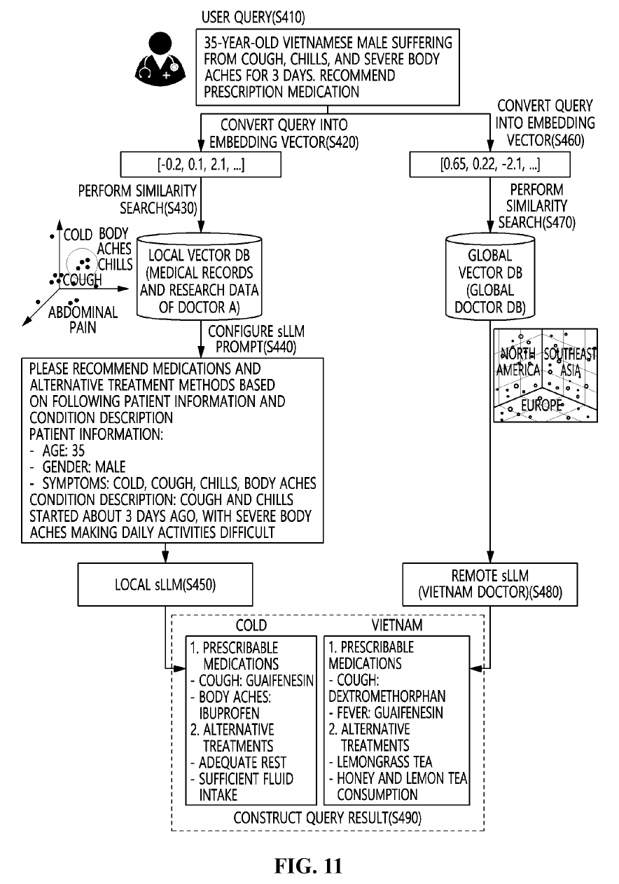

FIG. 11 is a diagram illustrating a query processing procedure based on a distributed sLLM according to an embodiment of the present disclosure.

Referring to FIG. 11, it can be seen that, in the result of a user query such as “A 35-year-old Vietnamese male who has been suffering from coughing, chills, and severe body aches for three days, please recommend a prescription drug,” the keyword ‘cold’ appears repeatedly, and the query is configured to include the keyword “cold” more extensively at step S410.

A distributed sLLM-based query processing apparatus may convert the query into an embedding vector at step S420.

The distributed sLLM-based query processing apparatus may perform similarity search on a local vector DB at step S430.

The distributed sLLM-based query processing apparatus may configure a sLLM prompt based on search results at step S440.

Here, the structure of the query may be predefined in the form of a template, as in the case of the prompt.

The distributed sLLM-based query processing apparatus may query the local sLLM through the newly configured prompt at step S450.

At step S450, a newly configured query may be issued to the local sLLM, and then a first query result may be generated.

Meanwhile, the distributed sLLM-based query processing apparatus may query multiple remote sLLMs based on the user query.

The embedding vector of the user query may be generated through the embedding model having a form such as that of the global vector DB at step S460, and then similarity search may be performed at step S470.

Here, the results of similarity search may include summary information and access information for the remote sLLMs.

The remote sLLMs to be queried may be selected based on the similarity degree or one to three criteria at step S480.

Step S480 is an example in which remote sLLMs are selected based on a region such as “Vietnam”. The user query is transmitted to the selected remote sLLMs, and query results are obtained therefrom.

At step S490, a second query result may be generated by aggregating the obtained results.

At step S490, the first query result and the second query result may be integrated, and an integrated result may be returned as a response to the user query.

The present disclosure processes each user query based on sLLMs depending on the user data, and collects query results from remote sLLMs similar to the user query. The remote sLLMs may be sLLMs tuned with data of enterprises or personal data of persons who agreed to share data. Through this process, natural language queries from users may be processed on edge devices with limited resources, and queries may be handled by integrating data from individuals who share the same application domain or have similar interests, thereby deriving personalized query results. Furthermore, when personal data (local data) and pieces of data of other persons are changed or modified in edge devices, recency may be maintained through synchronization.

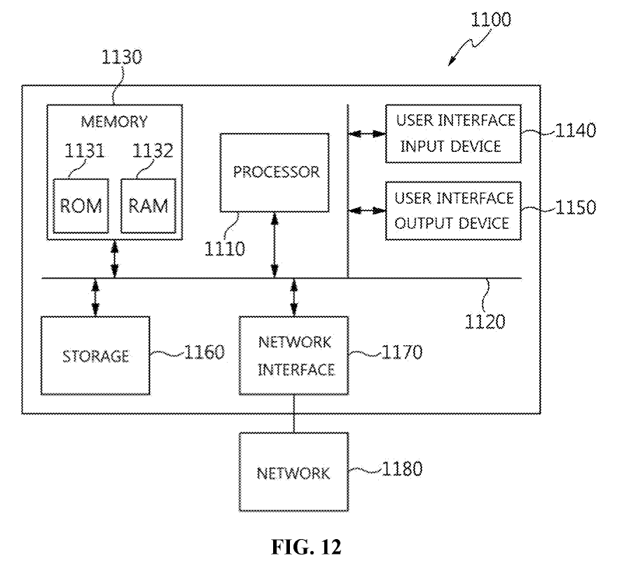

FIG. 12 is a diagram illustrating a computer system according to an embodiment of the present disclosure.

Referring to FIG. 12, a query processing apparatus based on a distributed sLLM according to an embodiment of the present disclosure may be implemented in a computer system 1100 such as a computer-readable storage medium. As illustrated in FIG. 12, the computer system 1100 may include one or more processors 1110, memory 1130, a user interface input device 1140, a user interface output device 1150, and storage 1160, which communicate with each other through a bus 1120. The computer system 1100 may further include a network interface 1170 connected to a network 1180. Each processor 1110 may be a Central Processing Unit (CPU) or a semiconductor device for executing processing instructions stored in the memory 1130 or the storage 1160. Each of the memory 1130 and the storage 1160 may be any of various types of volatile or nonvolatile storage media. For example, the memory 1130 may include Read-Only Memory (ROM) 1131 or Random Access Memory (RAM) 1132.

Further, query processing apparatus based on a distributed sLLM according to an embodiment of the present disclosure may include one or more processors 1110 and memory 1130 configured to store at least one program that is executed by the one or more processors 1110, wherein the at least one program is configured to receive a query from a user, complement a prompt corresponding to the query based on a result of similarity search of searching a preset local vector database for local data similar to the query, select a remote sLLM suitable for the query based on a result of similarity search of searching a preset global vector database for an embedding vector similar to the query, and integrate a response of the local sLLM to the complemented prompt and a response of the remote sLLM, and outputting an integrated result.

Here, the at least one program may be configured to determine preset application domains corresponding to keywords included in the query, and construct an embedding vector for searching the local vector database in accordance with the determined application domains.

Here, the at least one program may be configured to complement the query by adding meta-information including an access path to the local data to the query.

Here, the at least one program may be configured to determine preset application domains corresponding to keywords included in the query, and construct an embedding vector for searching the global vector database in accordance with the determined application domains.

Here, the result of similarity search on the global vector database may include summary information and access information for the remote sLLM.

Here, the at least one program may be configured to store the integrated output response in a query result cache, and provide a response stored in the query result cache with priority when an identical query is requested again.

The present disclosure may process user queries for a local sLLM fine-tuned with personal data and multiple remote sLLMs in order for an edge device having limited resources to support a large language model service personalized for individuals without the risk of information leakage to individuals or enterprises.

Further, the present disclosure may process queries for a sLLM fine-tuned with personal data and multiple sLLMs fine-tuned with pieces of data of other persons, and may derive personalized query results, thus improving user satisfaction.

Furthermore, the present disclosure may maintain recency by reflecting addition and modification of data when pieces of data of other persons, as well as personal data, are added and modified.

Furthermore, the present disclosure may improve user satisfaction and prevent information exposure through public or commercial services without LLMs requiring large-scale resources even in specific application domains such as medical care, law, and administration.

As described above, in the query processing apparatus and method based on a distributed sLLM according to embodiments of the present disclosure, the configurations and schemes in the above-described embodiments are not limitedly applied, and some or all of the above embodiments can be selectively combined and configured such that various modifications are possible.

What is claimed is:

1. A query processing apparatus based on a distributed small Large Language Model (sLLM), comprising:
one or more processors; and
a memory configured to store at least one program that is executed by the one or more processors,
wherein the at least one program is configured to:
receive a query from a user,
complement a prompt corresponding to the query based on a result of similarity search of searching a preset local vector database for local data similar to the query,
select a remote sLLM suitable for the query based on a result of similarity search of searching a preset global vector database for an embedding vector similar to the query, and
integrate a response of the local sLLM to the complemented prompt and a response of the remote sLLM, and output an integrated result.

2. The query processing apparatus of claim 1, wherein the at least one program is configured to:
determine preset application domains corresponding to keywords included in the query, and
construct an embedding vector for searching the local vector database in accordance with the determined application domains.

3. The query processing apparatus of claim 2, wherein the at least one program is configured to complement the query by adding meta-information including an access path to the local data to the query.

4. The query processing apparatus of claim 1, wherein the at least one program is configured to:
determine preset application domains corresponding to keywords included in the query, and
construct an embedding vector for searching the global vector database in accordance with the determined application domains.

5. The query processing apparatus of claim 4, wherein the result of similarity search on the global vector database includes summary information and access information for the remote sLLM.

6. The query processing apparatus of claim 1, wherein the at least one program is configured to store the integrated output response in a query result cache, and provide a response stored in the query result cache with priority when an identical query is requested again.

7. A query processing method based on a distributed small Large Language Model (sLLM), performed by a query processing apparatus based on sLLM, the query processing method comprising:
receiving a query from a user;
complementing a prompt corresponding to the query based on a result of similarity search of searching a preset local vector database for local data similar to the query;
selecting a remote sLLM suitable for the query based on a result of similarity search of searching a preset global vector database for an embedding vector similar to the query; and
integrating a response of the local sLLM to the complemented prompt and a response of the remote sLLM, and outputting an integrated result.

8. The query processing method of claim 7, wherein complementing the prompt comprises:
determining preset application domains corresponding to keywords included in the query, and constructing an embedding vector for searching the local vector database in accordance with the determined application domains.

9. The query processing method of claim 8, wherein complementing the prompt further comprises:
complementing the query by adding meta-information including an access path to the local data to the query.

10. The query processing method of claim 7, wherein selecting the remote sLLM comprises:
determining preset application domains corresponding to keywords included in the query, and constructing an embedding vector for searching the global vector database in accordance with the determined application domains.

11. The query processing method of claim 10, wherein the result of similarity search on the global vector database includes summary information and access information for the remote sLLM.

12. The query processing method of claim 7, wherein outputting the integrated result comprises:
storing the integrated output response in a query result cache, and providing a response stored in the query result cache with priority when an identical query is requested again.
